(19) United States
(12) Patent Application Publication
(10) Pub. No.: US 2017/0254401 A1
(43) Pub. Date: Sep. 7, 2017

(54) DIFFERENTIAL DEVICE

(71) Applicant: MUSASHI SEIMITSU INDUSTRY CO., LTD., TOYOHASHI-SHI (JP)

(72) Inventors: Shinya MATSUOKA, TOYOHASHI-SHI (JP); Takanori NOGUCHI, TOYOHASHI-SHI (JP); Shohei SAKATA, TOYOHASHI-SHI (JP)

(21) Appl. No.: 15/450,478

(22) Filed: Mar. 6, 2017

(30) Foreign Application Priority Data
Mar. 7, 2016 (JP) 2016-043868

(51) Int. Cl. F16H 48/36; F16H 57/04; F16H 48/06

(52) U.S. Cl. CPC F16H 48/36; F16H 48/06; F16H 57/043; F16H 57/0427; F16H 57/0483; F16H 57/0423

(57) ABSTRACT

In a differential device including: a first transmission member having a first axis an eccentric rotating member in which are joined a hollow first output boss and an eccentric shaft portion; a second transmission member rotatably supported on the shaft portion; a third transmission member having a hollow second output boss rotatable around the first axis and facing the second transmission member; a first speed change mechanism between the first and second transmission members; and a second speed change mechanism between the second and third transmission members, one of mating faces of a first hub of a differential case and a first drive shaft fitted and supported in the hub is provided with a helical groove that can draw in lubricating oil within a transmission case. An oil passage communicating the groove with the first speed change mechanism is provided between the differential case and the rotating member.

### BACKGROUND OF THE INVENTION

Field of the Invention

The present invention relates to a differential device in which rotational power inputted into a differential case can be distributed and transmitted between first and second drive axles via a differential mechanism within the differential case.

Description of the Related Art

As the differential device, as shown in for example Japanese Patent Application Laid-open No. 2012-67889, a differential mechanism in which a differential gear formed from a bevel gear is supported on a differential case and a pair of side gears sandwiching the differential gear from axially opposite sides of the differential case are made to mesh with the differential gear is conventionally generally used, but this structure has the problem that the differential mechanism, and therefore the differential case, increase in size in the axial direction.

Furthermore, as in a transmission device shown in for example Japanese Patent No. 4814351, a reduction gear is known with a structure that includes a first transmission member having a first axis as a central axis, an eccentrically rotating member having integrally linked to each other a main shaft part that is connected to the first shaft and can rotate around the first axis and an eccentric shaft portion having as a central axis a second axis that is eccentric from the first axis, a second transmission member that is disposed so as to oppose the first transmission member and is rotatably supported on the eccentric shaft portion, a third transmission member that is disposed so as to oppose the second transmission member, is connected to the second shaft, and is rotatable around the first axis, a first speed change mechanism that can transmit torque while changing the speed between the first and second transmission members, and a second speed change mechanism that can transmit torque while changing the speed between the second and third transmission members, the reduction gear enabling speed reduction drive from one of the first and second shafts to the other. The arrangement of Japanese Patent No. 4814351 has the advantage that a case can be easily made flat and small in the axial direction by providing an operative connection between the first and third transmission members and the second transmission member by means of the first and second speed change mechanisms, which are compact in the axial direction, (for example, a rolling ball type speed change mechanism having a ball and a pair of annular wave-shaped transmission grooves on which the ball rolls).

The transmission device of Japanese Patent Application Laid-open No. 2012-67889 is a differential device but has a structure such that it is inherently difficult to make the differential case flat and small in the axial direction as described above.

On the other hand, the transmission device of Japanese Patent No. 4814351 has a structure that can be easily made flat and small in the axial direction of the case, but there is no technical concept for making it possible for the structure to be used as a differential device (for example, a technical concept such as the gear ratio of each of the first and second speed change mechanisms being set at a specific ratio), and because of this it is impossible to distribute rotational power between the first and second shafts even by for example inputting the rotational power into the case. Furthermore, the transmission device of Japanese Patent No. 4814351 is not provided with technical means that efficiently supplies lubricating oil to a speed change mechanism present in a confined internal space of the flattened and small differential case (for example, the first speed change mechanism).

### SUMMARY OF THE INVENTION

The present invention has been accomplished in light of such circumstances, and it is an object thereof to provide a differential device that, while exploiting the advantages of a transmission device such as that in Japanese Patent No. 4814351, enables this to be used as a differential device effectively and, furthermore, enables lubricating oil to be efficiently supplied to a first speed change mechanism present in a confined internal space of a differential case.

In order to achieve the object, according to a first aspect of the present invention, there is provided a differential device comprising: a differential case that has first and second hubs arranged on a first axis on opposite side parts, is disposed within a transmission case, and rotates around the first axis upon being subjected to rotational power, a first transmission member that can rotate around the first axis together with the differential case, an eccentric rotating member that has integrally linked a hollow first output boss and an eccentric shaft portion, the first output boss being capable of rotating around the first axis, and the eccentric shaft portion having as a central axis a second axis that is eccentric from the first axis, a second transmission member that is disposed so as to oppose the first transmission member and is rotatably supported on the eccentric shaft portion, a third transmission member that has a hollow second output boss and is disposed so as to oppose the second transmission member, the second output boss being capable of rotating around the first axis, a first speed change mechanism that can transmit torque between the first and second transmission members while changing a speed, and a second speed change mechanism that can transmit torque between the second and third transmission members while changing a speed, the first and second speed change mechanisms driving the third transmission member with a speed increase ratio of twice a speed of the first transmission member when the eccentric rotating member is fixed, wherein the first output boss is spline fitted via a hollow part of the first output boss onto a first drive shaft rotatably fitted into and supported on the first hub and the second output boss is spline fitted via a hollow part of the second output boss onto a second drive shaft rotatably fitted into and supported on the second hub, and one of mating faces of the first drive shaft and the first hub is provided with a helical groove that can draw in lubricating oil within the transmission case by means of relative rotation between the first hub and the first drive shaft from an outer end side of the first hub to an inner end side, and an oil passage is provided between the differential case and the eccentric rotating member, the oil passage providing communication between an outlet of the helical groove and an inner peripheral side of the first speed change mechanism.

In accordance with the first aspect, since there are provided the differential case, which is disposed within the transmission case, and subjected to rotational power, the first transmission member, which can rotate around the first axis together with the differential case, the eccentric rotating member, which has integrally linked the hollow first output boss and the eccentric shaft portion, the first output boss being capable of rotating around the first axis, and the eccentric shaft portion having as a central axis the second axis that is eccentric from the first axis, the second transmission member, which is disposed so as to oppose the first transmission member and is rotatably supported on the eccentric shaft portion, the third transmission member, which has the hollow second output boss and is disposed so as to oppose the second transmission member, the second output boss being capable of rotating around the first axis, the first speed change mechanism, which can transmit torque between the first and second transmission members while changing the speed, and the second speed change mechanism, which can transmit torque between the second and third transmission members while changing the speed, the first and second speed change mechanisms driving the third transmission member with a speed increase ratio of twice a speed of the first transmission member when the eccentric rotating member is fixed, it is possible to provide the differential device that can easily be made flat and small in the axial direction. Moreover, since one of the mating faces of the first drive shaft and the first hub is provided with the helical groove, which can, by means of relative rotation therebetween, draw in lubricating oil within the transmission case from the outer end side of the first hub to the inner end side, and the oil passage is provided between the differential case and the eccentric rotating member, the oil passage providing communication between the outlet of the helical groove and the inner peripheral side of the first speed change mechanism, it is possible to draw in lubricating oil from the transmission case side to the differential case side through the helical groove, and subsequently efficiently supply the lubricating oil to the first speed change mechanism side by scattering it outward in the radial direction between the differential case and the eccentric rotating member by the action of centrifugal force.

According to a second aspect of the present invention, in addition to the first aspect, the eccentric rotating member is provided with an oil hole, the oil hole guiding lubricating oil that has flowed from the outlet of the helical groove into a spline fitting part between the first drive shaft and the first output boss toward the inner peripheral side of the first speed change mechanism.

In accordance with the second aspect, since the eccentric rotating member is provided with the oil hole, the oil hole guiding lubricating oil that has flowed from the outlet of the helical groove into the spline fitting part between the first drive shaft and the first output boss toward the inner peripheral side of the first speed change mechanism, it becomes possible to supply lubricating oil that has flowed into the spline fitting part (that is, the hollow part of the first output boss) to the inner peripheral side of the first speed change mechanism through the oil hole, thus enabling the first speed change mechanism to be more efficiently lubricated.

According to a third aspect of the present invention, in addition to the first or second aspect, an opening, on a side opposite to the helical groove, of the hollow part of the first output boss is blocked.

In accordance with the third aspect, since the opening, on the side opposite to the helical groove, of the hollow part of the first output boss is blocked, even when the helical groove outlet communicates with the hollow part of the first output boss, it is possible to efficiently supply the lubricating oil that has come out of the helical groove outlet toward the first speed change mechanism side without passing through the hollow part of the first output boss.

According to a fourth aspect of the present invention, there is provided a differential device comprising: a differential case that has first and second hubs arranged on a first axis on opposite side parts, is disposed within a transmission case, and rotates around the first axis upon being subjected to rotational power, a first transmission member that can rotate around the first axis together with the differential case, an eccentric rotating member that has integrally linked a hollow first output boss and an eccentric shaft portion, the first output boss being capable of rotating around the first axis, and the eccentric shaft portion having as a central axis a second axis that is eccentric from the first axis, a second transmission member that is disposed so as to oppose the first transmission member and is rotatably supported on the eccentric shaft portion, a third transmission member that has a hollow second output boss and is disposed so as to oppose the second transmission member, the second output boss being capable of rotating around the first axis, a first speed change mechanism that can transmit torque between the first and second transmission members while changing a speed, and a second speed change mechanism that can transmit torque between the second and third transmission members while changing a speed, the first and second speed change mechanisms driving the third transmission member with a speed increase ratio of twice a speed of the first transmission member when the eccentric rotating member is fixed, wherein the first output boss is spline fitted via a hollow part of the first output boss onto a first drive shaft rotatably fitted into and supported on the first hub and the second output boss is spline fitted via a hollow part of the second output boss onto a second drive shaft rotatably fitted into and supported on the second hub, the first output boss is integrally and connectedly provided with a first tubular shaft rotatably fitted into and supported on the first hub, one of mating faces of the first hub and the first tubular shaft is provided with a first helical groove that can draw in lubricating oil within the transmission case by means of relative rotation between the first tubular shaft and the first hub from an outer end side of the first hub to an inner end side, and an oil passage is provided between the differential case and the eccentric rotating member, the oil passage providing communication between an outlet of the first helical groove and an inner peripheral side of the first speed change mechanism.

In accordance with the fourth aspect, even when the first output boss is integrally and connectedly provided with the first tubular shaft rotatably fitted into and supported on the first hub, since one of the mating faces of the first hub and the first tubular shaft is provided with the first helical groove, which can, by means of relative rotation therebetween, draw in lubricating oil within the transmission case from the outer end side of the first hub to the inner end side, and the oil passage is provided between the differential case and the eccentric rotating member, the oil passage providing communication between the outlet of the first helical groove and the inner peripheral side of the first speed change mechanism, the same effects as those of the first aspect can be achieved.

According to a fifth aspect of the present invention, in addition to the fourth aspect, the second output boss is integrally and connectedly provided with a second tubular shaft rotatably fitted into and supported on the second hub, an opening, on a side opposite to the first drive shaft, of the hollow part of the first output boss and an opening, on a side opposite to the second drive shaft, of the hollow part of the second output boss are blocked, and a seal member is disposed between the transmission case and an outer end part of each of the first and second tubular shafts extending outward from the first and second hubs respectively.

In accordance with the fifth aspect, since the opening, on the side opposite to the first drive shaft, of the hollow part of the first output boss and the opening, on the side opposite to the second drive shaft, of the hollow part of the second output boss are blocked, and the seal member is disposed between the transmission case and the outer end part of each of the first and second tubular shafts extending outward from the first and second hubs respectively, even when the first and second drive shafts are pulled out from the first and second tubular shafts, it is possible to prevent the lubricating oil within the transmission case and the differential case from leaking out, and the ease of maintenance becomes good.

According to a sixth aspect of the present invention, in addition to any one of the first to fifth aspects, the first speed change mechanism comprises a wave-shaped annular first transmission groove that is present on a face, opposing the second transmission member, of the first transmission member and has the first axis as a center, a wave-shaped annular second transmission groove that is present on a face, opposing the first transmission member, of the second transmission member, has the second axis as a center, and has a different wave number from that of the first transmission groove, and a plurality of first rolling bodies that are each disposed in a plurality of intersecting parts between the first and second transmission grooves and are involved in speed change and transmission between the first and second transmission members while rolling in the first and second transmission grooves, the second speed change mechanism comprises a wave-shaped annular third transmission groove that is present on a face, opposing the third transmission member, of the second transmission member and has the second axis as a center, a wave-shaped annular fourth transmission groove that is present on a face, opposing the second transmission member, of the third transmission member, has the first axis as a center, and has a different wave number from that of the third transmission groove, and a plurality of second rolling bodies that are each disposed in a plurality of intersecting parts between the third and fourth transmission grooves and are involved in speed change and transmission between the second and third transmission members while rolling in the third and fourth transmission grooves, and when the wave number of the first transmission groove is Z1, the wave number of the second transmission groove is Z2, the wave number of the third transmission groove is Z3, and the wave number of the fourth transmission groove is Z4, (Z1/Z2)×(Z3/Z4)=2 holds.

In accordance with the sixth aspect, since the plurality of first and second rolling bodies can be involved in transmission at the same time, the transmission torque is dispersed in the peripheral direction of each of the transmission members on opposite sides of the rolling bodies, thus enabling the differential device having light weight and high durability to be provided.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 is a longitudinal sectional front view of a differential device related to a first embodiment of the present invention.

FIG. 2 is an exploded perspective view of an essential part (differential mechanism) of the differential device.

FIG. 3 is a sectional view from arrowed line 3-3 in FIG. 1.

FIG. 4 is a sectional view from arrowed line 4-4 in FIG. 1.

FIG. 5 is a sectional view from arrowed line 5-5 in FIG. 1.

FIG. 6 is an enlarged longitudinal sectional view showing the essential part (differential mechanism) of the differential device together with the flow of lubricating oil.

FIG. 7 is a longitudinal sectional front view (a view corresponding to FIG. 1) of a differential device related to a second embodiment of the present invention.

### DESCRIPTION OF THE PREFERRED EMBODIMENTS

Embodiments of the present invention are explained below by reference to the attached drawings.

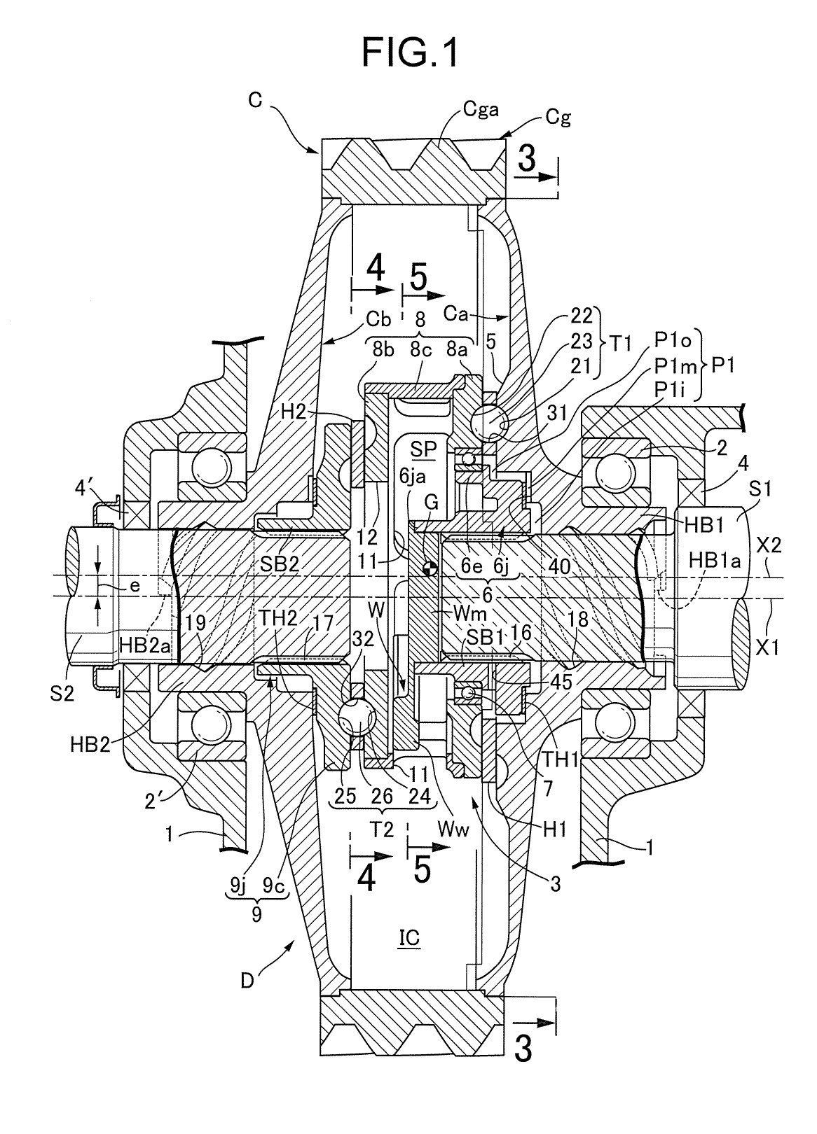

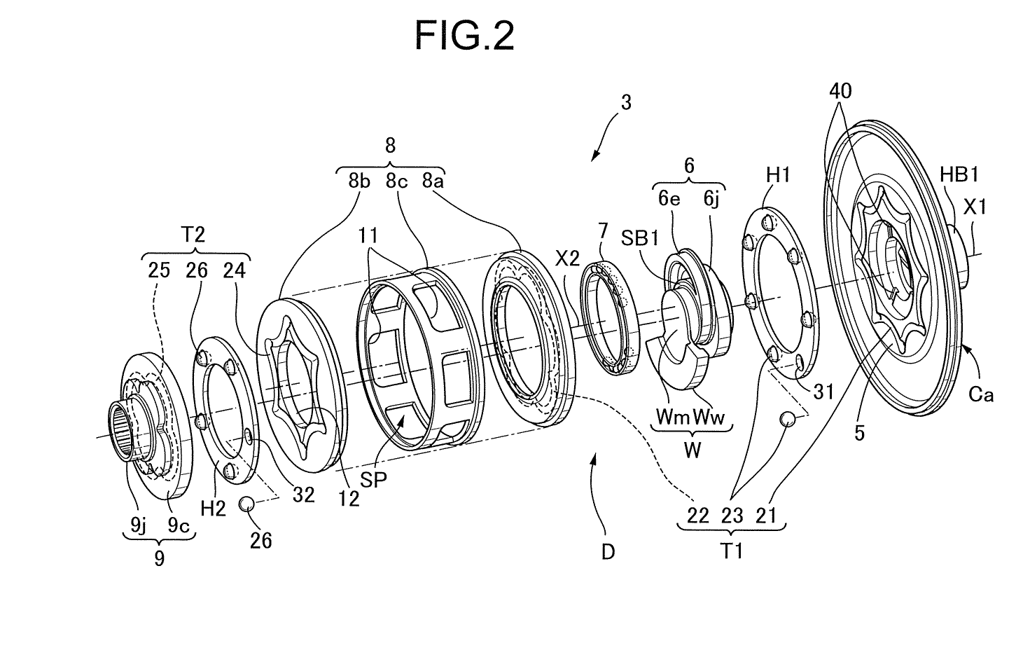

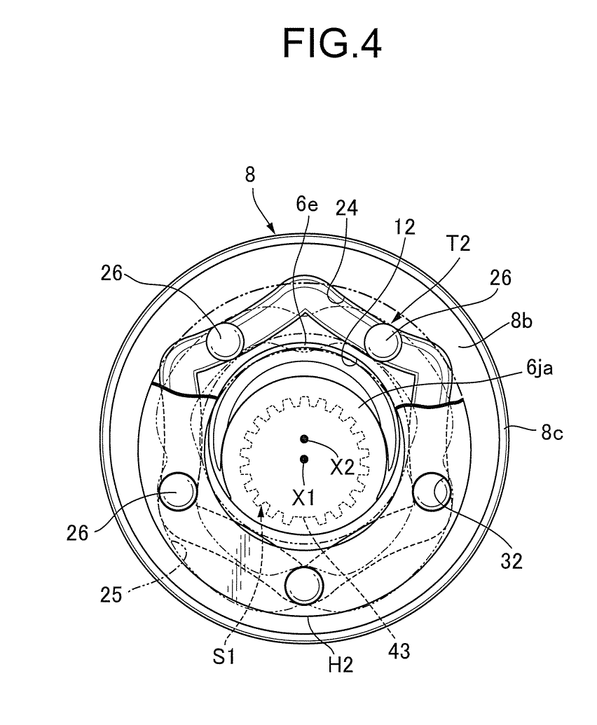

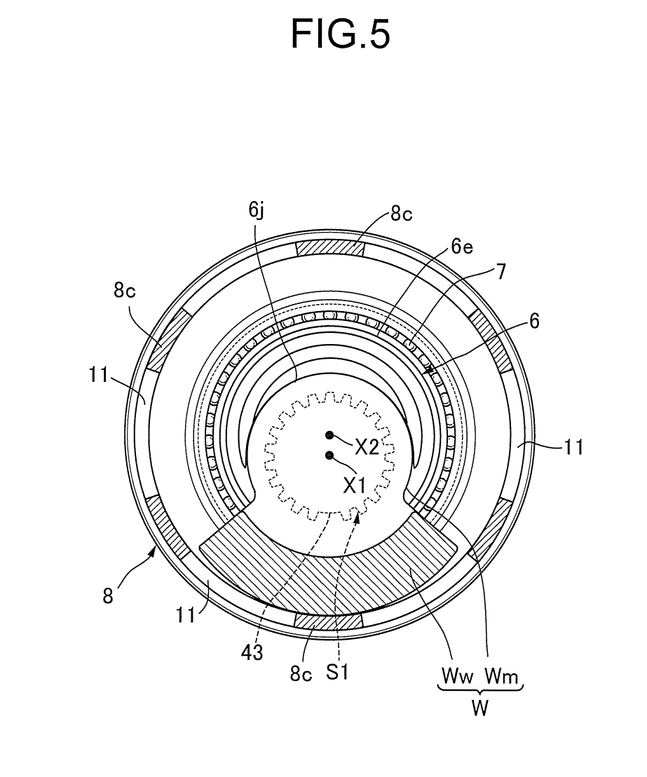

A first embodiment of the present invention shown in FIG. 1 to FIG. 6 is now explained. In FIG. 1, a differential device D as a transmission device and a speed change device are together housed within a transmission case 1 of an automobile.

This differential device D distributes rotation of a ring gear Cg, which rotates in operative connection with the output side of the speed change device, between left and right drive axles S1 and S2 (that is, first and second drive shafts) relatively rotatably arranged on a central axis, that is, a first axis X1, of the differential device D while allowing differential rotation between the two drive axles S1 and S2. Seal members 4 and 4′ provide sealing between each of the drive axles S1 and S2 and the transmission case 1.

A bottom part of the transmission case 1 is formed as an oil pan (not illustrated) that can collect a predetermined amount of lubricating oil. The lubricating oil collected within the oil pan is stirred vigorously by rotation of a rotating portion within the transmission case 1, for example, a differential case C, which is described later, and is scattered over a wide range in the space within the case 1, this scattered lubricating oil being capable of lubricating each part within the case 1, that is, parts that are to be lubricated. In addition to the above lubricating structure (or instead thereof), lubricating oil fed under pressure by pumping means such as an oil pump and the like may be forcibly supplied under pressure to each part within the transmission case 1.

The differential device D is formed from the differential case C and a differential mechanism 3 housed within the differential case C and described later, the differential case C being a power transmission case supported on the transmission case 1 so that it can rotate around the first axis X1. The differential case C includes the ring gear Cg, which is formed from a helical gear having helical teeth Cga provided on the outer periphery of a short cylindrical gear main body, and a pair of left and right first and second side wall plate parts Ca and Cb having outer peripheral end parts joined to axially opposite end parts of the ring gear Cg. At least one of the side wall plate parts Ca and Cb is provided with a drain hole (not illustrated) in the vicinity of the outer peripheral end, the drain hole being capable of appropriately discharging excess lubricating oil within the differential case C by means of centrifugal force, etc.

Furthermore, the first and second side wall plate parts Ca and Cb each integrally have cylindrical first and second hubs HB1 and HB2 arranged on the first axis X1 in respective inner peripheral end parts, and outer peripheral parts of the hubs HB1 and HB2 are rotatably supported on the transmission case 1 via bearings 2 and 2′. Furthermore, the first and second drive axles Si and S2 are each fitted into and supported on inner peripheral parts of the first and second hubs HB1 and HB2 so that the first and second drive axles S1 and S2 can rotate around the first axis X1. First and second helical grooves 18 and 19 are formed in at least one of the mating faces thereof (in the illustrated example the inner peripheral faces of the hubs HB1 and HB2), the first and second helical grooves 18 and 19 drawing in scattered lubricating oil within the transmission case 1 into the differential case C accompanying relative rotation between the hubs HB1 and HB2 and the drive axles S1 and S2 at least while the automobile is moving forward (that is, while the drive axles S1 and S2 are rotating forward). The outer end of each of the helical grooves 18 and 19 opens within the transmission case 1 and the inner end opens within the differential case C. Furthermore, guide parts HB1a and HB2a are projectingly provided on outer end faces of the hubs HB1 and HB2, the guide parts HB1a and HB2a being capable of efficiently guiding the flow of lubricating oil from the interior of the transmission case 1 into the outer end opening (that is, the inlet) of each of the helical grooves 18 and 19.

In the present embodiment, the helical grooves 18 and 19 are illustrated as lubricating oil supply means for supplying lubricating oil within the transmission case 1 into the differential case C, but in addition to such helical grooves 18 and 19 (or instead thereof), as other lubricating oil supply means, for example, lubricating oil fed under pressure by pumping means such as an oil pump and the like may be supplied into the differential case C via an oil passage (not illustrated) provided in the drive axles S1 and S2 and/or the differential case C. Alternatively, as yet other lubricating oil supply means, a through hole may be formed in at least one of the side wall plate parts Ca and Cb of the differential case C, the through hole providing direct communication between the interior and the exterior thereof. The helical grooves 18 and 19 may be formed in outer peripheral faces of the drive axles S1 and S2.

The structure of the differential mechanism 3 within the differential case C is now explained. The differential mechanism 3 includes a first transmission member 5 that is provided integrally with the first side wall plate part Ca and is rotatable around the first axis X1, an eccentric rotating member 6 in which are integrally joined a hollow main shaft portion 6j that integrally includes a cylindrical first spline boss SB1 (that is, a first output boss) fitted onto the first drive axle S1 by a spline fitting 16 and rotatable around the first axis X1, and an eccentric shaft portion 6e having as a central axis a second axis X2 that is eccentric from the first axis X1 only by a predetermined amount of eccentricity e, an annular second transmission member 8 that has one side part disposed so as to oppose the first transmission member 5 and is rotatably supported on the eccentric shaft portion 6e via a bearing 7, which is a ball bearing, an annular third transmission member 9 that is disposed so as to oppose the other side part of the second transmission member 8, is fitted onto the second drive axle S2 by a spline fitting 17, and is rotatable around the first axis X1, a first speed change mechanism T1 that can transmit torque between the first and second transmission members 5 and 8 while changing the speed, and a second speed change mechanism T2 that can transmit torque between the second and third transmission members 8 and 9 while changing the speed.

Due to the second transmission member 8 being fitted onto and supported on the eccentric shaft portion 6e of the eccentric rotating member 6 rotating around the first axis X1 so that the second transmission member 8 can rotate around the second axis X2, the second transmission member 8 can revolve around the first axis X1 with respect to the main shaft portion 6j while spinning around the second axis X2 with respect to the eccentric shaft portion 6e accompanying rotation of the eccentric rotating member 6 around the first axis X1.

Furthermore, the second transmission member 8 includes an annular first half body 8a rotatably supported on the eccentric shaft portion 6e of the eccentric rotating member 6 via the bearing 7, an annular second half body 8b opposing the first half body 8a across a gap, and a basically cylindrical linking member 8c integrally linking the two half bodies 8a and 8b. The first speed change mechanism T1 is provided between the first half body 8a and the first transmission member 5, and the second speed change mechanism T2 is provided between the second half body 8b and the third transmission member 9. A hollow part SP of the second transmission member 8 is defined between the first and second half bodies 8a and 8b and the linking member 8c.

The linking member 8c is provided with a plurality of first oil flow holes 11 at equal intervals in the peripheral direction, the first oil flow holes 11 providing communication between an internal space IC of the differential case C and the hollow part SP of the second transmission member 8, thus enabling lubricating oil scattered in the internal space IC of the differential case C to be guided into the hollow part SP through the first oil flow holes 11. Furthermore, formed in the second half body 8b is a circular second oil flow hole 12 having the second axis X2 as a center and providing communication between the hollow part SP and an inner peripheral side of the second speed change mechanism T2.

Moreover, the third transmission member 9 is formed by integrally joining a main shaft portion 9j and a circular plate portion 9c, the main shaft portion 9j integrally including a cylindrical second spline boss SB2 (that is, a second output boss) that is fitted onto the second drive axle S2 by the spline fitting 17 in a hollow part of the third transmission member 9 and is rotatable around the first axis X1, and the circular plate portion 9c being coaxially and connectedly provided on an inner end part of the main shaft portion 9j.

Furthermore, inner peripheral faces of one end part and the other end part of the linking member 8c are concavo-convex engaged with the first half body 8a and the second half body 8b respectively, and the fitted parts are fixed by appropriate fixing means such as welding, swaging or the like.

A first thrust washer TH1 is disposed between mutually opposing faces of the eccentric rotating member 6 and the inside face of the first side wall plate part Ca of the differential case C, the first thrust washer TH1 allowing relative rotation therebetween, and a first oil passage P1 is formed in the mutually opposing faces, the first oil passage P1 providing communication between the inner peripheral side of the first speed change mechanism T1 and the inner end opening (that is, the outlet) of the first helical groove 18 via a back face of the first thrust washer TH1. This first oil passage P1 is formed from an annular inner peripheral side oil passage portion P1i that the outlet of the first helical groove 18 faces, an intermediate oil passage portion P1m defined between the back face of the first thrust washer TH1 and a plurality of channels 40 provided in the inside face of the first side wall plate part Ca, and an annular outer peripheral side oil passage portion P1o communicating directly with the inner peripheral side of the first speed change mechanism T1. Not only the inner peripheral side of the first speed change mechanism T1 but also the bearing 7 face the outer peripheral side oil passage portion P1o, and lubricating oil flowing through the first oil passage P1 can be supplied from the outer peripheral side oil passage portion P1o to both the first speed change mechanism T1 and the bearing 7. The first oil passage P1 thus forms the oil passage of the present invention that provides communication between the outlet of the first helical groove 18 as a helical groove and the inner peripheral side of the first speed change mechanism T1.

Disposed between the mutually opposing faces of the inside face of the second side wall plate part Cb of the differential case C and the third transmission member 9 is a second thrust washer TH2 that allows relative rotation therebetween.

Furthermore, the differential mechanism 3 includes a balance weight W mounted on the main shaft portion 6j of the eccentric rotating member 6, the balance weight W having the opposite phase to an overall center of gravity G of the second transmission member 8 and the eccentric shaft portion 6e of the eccentric rotating member 6 with respect to the first axis X1 and having a rotational radius that is larger than the rotational radius of the overall center of gravity G. This balance weight W is formed from a disk-shaped mounting base part Wm and a weight part Ww that is fixedly provided on a predetermined region in the peripheral direction of the mounting base part Wm.

The hollow part SP of the second transmission member 8 (the linking member 8c) is utilized as a housing space for housing the balance weight W. That is, with regard to the main shaft portion 6j of the eccentric rotating member 6, in particular the first spline boss SB1, an inner end portion 6ja thereof extends to the hollow part SP, the mounting base part Wm of the balance weight W is fixedly fitted into the open end of the extending end part (the inner end portion 6ja), and an opening on the inner end side of the hollow main shaft portion 6j (the first spline boss SB1) is blocked by the mounting base part Wm.

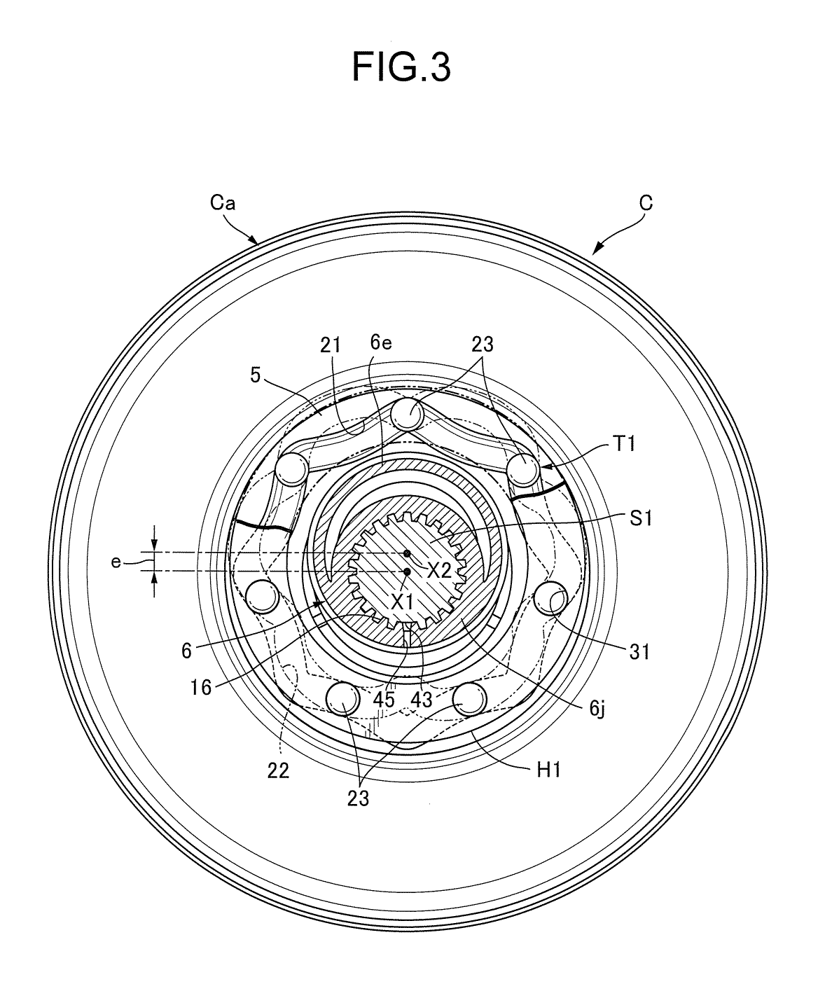

Furthermore, at least one oil hole 45 is formed in the eccentric rotating member 6 (the main shaft portion 6j) so as to extend through the main shaft portion 6j in the radial direction, the oil hole 45 guiding to the inner peripheral side of the first speed change mechanism T1 lubricating oil that has flowed from the outlet of the first helical groove 18 into the spline fitting part 16 of the first drive shaft S1 and the main shaft portion 6j (that is, the first spline boss SB1). An inner end opening of the oil hole 45 communicates directly with a spline tooth-missing part 43 on the outer peripheral side of the first drive axle S1 as clearly shown in FIG. 3, and lubricating oil flowing through the spline tooth-missing part 43 is efficiently supplied to the oil hole 45 and can be smoothly guided therefrom to the inner peripheral side of the first speed change mechanism T1.

As shown in FIG. 1 to FIG. 3, a wave-shaped annular first transmission groove 21 having the first axis X1 as a center is formed in an inside face, opposing one side part (the first half body 8a) of the second transmission member 8, of the first transmission member 5, and this first transmission groove 21 extends in the peripheral direction along a hypotrochoid curve having as a base circle an imaginary circle having the first axis X1 as its center in the illustrated example. On the other hand, a wave-shaped annular second transmission groove 22 having the second axis X2 as a center is formed in one side part (the first half body 8a), opposing the first transmission member 5, of the second transmission member 8. The second transmission groove 22 extends in the peripheral direction along an epitrochoid curve having as a base circle an imaginary circle having the second axis X2 as a center in the illustrated example, has a wave number that is smaller than the wave number of the first transmission groove 21, and intersects with the first transmission groove 21 at a plurality of locations. A plurality of first rolling balls 23 as first rolling bodies are disposed in intersecting parts (that is, overlapping parts) between the first transmission groove 21 and the second transmission groove 22, each first rolling ball 23 being capable of rolling on inside faces of the first and second transmission grooves 21 and 22.

An annular flat first retaining member H1 is disposed between opposing faces of the first transmission member 5 and the second transmission member 8 (the first half body 8a). The first retaining member H1 has a plurality of circular first retaining holes 31 at equal intervals in the peripheral direction, the plurality of circular first retaining holes 31 rotatably retaining the plurality of first rolling balls 23 while keeping the gap therebetween constant so that a state in which the plurality of first rolling balls 23 are engaged with the first and second transmission grooves 21 and 22 in the mutually intersecting parts between the two transmission grooves 21 and 22 can be maintained.

Furthermore, as shown in FIGS. 1, 2, and 4, a wave-shaped annular third transmission groove 24 having the second axis X2 as a center is formed in the other side part (the second half body 8b) of the second transmission member 8, and the third transmission groove 24 extends in the peripheral direction along a hypotrochoid curve having as a base circle an imaginary circle having the second axis X2 as a center in the illustrated example. On the other hand, a wave-shaped annular fourth transmission groove 25 having the first axis X1 as a center is formed in a face, opposing the second transmission member 8, of the third transmission member 9, that is, an inside face of the circular plate portion 9c. The fourth transmission groove 25 extends in the peripheral direction along an epitrochoid curve having as a base circle an imaginary circle having the first axis X1 as a center in the illustrated example, has a smaller wave number than the wave number of the third transmission groove 24, and intersects the third transmission groove 24 at a plurality of locations. A plurality of second rolling balls 26 as second rolling bodies are disposed in intersecting parts (overlapping parts) of the third transmission groove 24 and the fourth transmission groove 25, and each second rolling ball 26 can roll on inside faces of the third and fourth transmission grooves 24 and 25. Furthermore, in the present embodiment, the trochoidal coefficient of the first and second transmission grooves 21 and 22 is set at a value that is different from the trochoidal coefficient of the third and fourth transmission grooves 24 and 25.

An annular flat second retaining member H2 is disposed between mutually opposing faces of the third transmission member 9 and the second transmission member 8 (the second half body 8b). The second retaining member H2 has a plurality of circular second retaining holes 32 at equal intervals in the peripheral direction, the second retaining holes 32 rotatably retaining the plurality of second rolling balls 26 while keeping the gap therebetween constant so that a state in which the plurality of second rolling balls 26 are engaged with the third and fourth transmission grooves 24 and 25 in intersecting parts of the two transmission grooves 24 and 25 can be maintained.

Furthermore, in the present embodiment, the shapes of the first retaining member H1 and the first and second transmission grooves 21 and 22 are set so that part of each of the first and second transmission grooves 21 and 22 is always open on the inner peripheral side or the outer peripheral side of the first retaining member H1 and the flow of lubricating oil into the first and second transmission grooves 21 and 22 through openings IN1 and IN2 is allowed.

In the present embodiment explained above, when the wave number of the first transmission groove 21 is Z1, the wave number of the second transmission groove 22 is Z2, the wave number of the third transmission groove 24 is Z3, and the wave number of the fourth transmission groove 25 is Z4, the first to fourth transmission grooves 21, 22, 24, and 25 are formed so that the equation below holds.

(Z1/Z2)×(Z3/Z4)=2

Desirably, as shown in the illustrated example, Z1=8, Z2=6, Z3=6, and Z4=4 or Z1=6, Z2=4, Z3=8, and Z4=6.

In the illustrated example, the first transmission groove 21 having eight waves and the second transmission groove 22 having six waves intersect at seven locations, seven of the first rolling balls 23 being disposed in the seven intersecting parts (overlapping parts), and the third transmission groove 24 having six waves and the fourth transmission groove 25 having four waves intersect at five locations, five of the second rolling balls 26 being disposed in the five intersecting parts (overlapping parts).

The first transmission groove 21, the second transmission groove 22, and the first rolling balls 23 form, in cooperation with one another, the first speed change mechanism T1, which can transmit torque between the first transmission member 5 and the second transmission member 8 while changing the speed, and the third transmission groove 24, the fourth transmission groove 25, and the second rolling balls 26 form, in cooperation with one another, the second speed change mechanism T2, which can transmit torque between the second transmission member 8 and the third transmission member 9 while changing the speed.

The operation of the first embodiment is now explained.

When, for example, in a state in which the eccentric rotating member 6 (and consequently the eccentric shaft portion 6e) is fixed by fixing the right first drive axle S1, the ring gear Cg is driven with the power from the engine, and the differential case C, and consequently the first transmission member 5, are rotated around the first axis X1, the eight wave-shaped first transmission groove 21 of the first transmission member 5 drives the six wave-shaped second transmission groove 22 of the second transmission member 8 via the first rolling balls 23, and the first transmission member 5 therefore drives the second transmission member 8 with a speed increase ratio of 8/6. In accordance with rotation of the second transmission member 8, since the six wave-shaped third transmission groove 24 of the second transmission member 8 drives the four wave-shaped fourth transmission groove 25 of the circular plate portion 9c of the third transmission member 9 via the second rolling balls 26, the second transmission member 8 drives the third transmission member 9 with a speed increase ratio of 6/4.

Ultimately, the first transmission member 5 drives the third transmission member 9 with a speed increase ratio of

(Z1/Z2)×(Z3/Z4)=(8/6)×(6/4)=2.

On the other hand, when, in a state in which the third transmission member 9 is fixed by fixing the left second drive axle S2, the differential case (and consequently the first transmission member 5) is rotated, due to the rotational driving force of the first transmission member 5 and the drive reaction force of the second transmission member 8 against the third transmission member 9, which is immobile, the second transmission member 8 revolves around the first axis X1 while spinning around the eccentric shaft portion 6e (the second axis X2) of the eccentric rotating member 6, thus driving the eccentric shaft portion 6e around the first axis X1. As a result, the first transmission member 5 drives the eccentric rotating member 6 with a speed increase ratio of twice.

When the load of the eccentric rotating member 6 and the load of the third transmission member 9 are in balance with each other or are changed from each other, the amount of spinning and the amount of revolving of the second transmission member 8 change steplessly, and the average value of the rotational speeds of the eccentric rotating member 6 and the third transmission member 9 becomes equal to the rotational speed of the first transmission member 5. In this way, the rotation of the first transmission member 5 is distributed between the eccentric rotating member 6 and the third transmission member 9, and the rotational power transmitted from the ring gear Cg to the differential case C can therefore be distributed between the left and right drive axles S1 and S2.

In this process, by making Z1=8, Z2=6, Z3=6, and Z4=4 or Z1=6, Z2=4, Z3=8, and Z4=6, the structure can be simplified while ensuring the differential function.

In this differential device D, since the rotational torque of the first transmission member 5 is transmitted to the second transmission member 8 via the first transmission groove 21, the plurality of first rolling balls 23, and the second transmission groove 22, and the rotational torque of the second transmission member 8 is transmitted to the third transmission member 9 via the third transmission groove 24, the plurality of second rolling balls 26, and the fourth transmission groove 25, transmission of torque between the first transmission member 5 and the second transmission member 8 and between the second transmission member 8 and the third transmission member 9 is carried out by dispersing it between a plurality of locations where the first and second rolling balls 23 and 26 are present, thus increasing the strength and lightening the weight of each of the transmission elements, such as the first to third transmission members 5, 8, and 9, the first and second rolling balls 23 and 26, and the like.

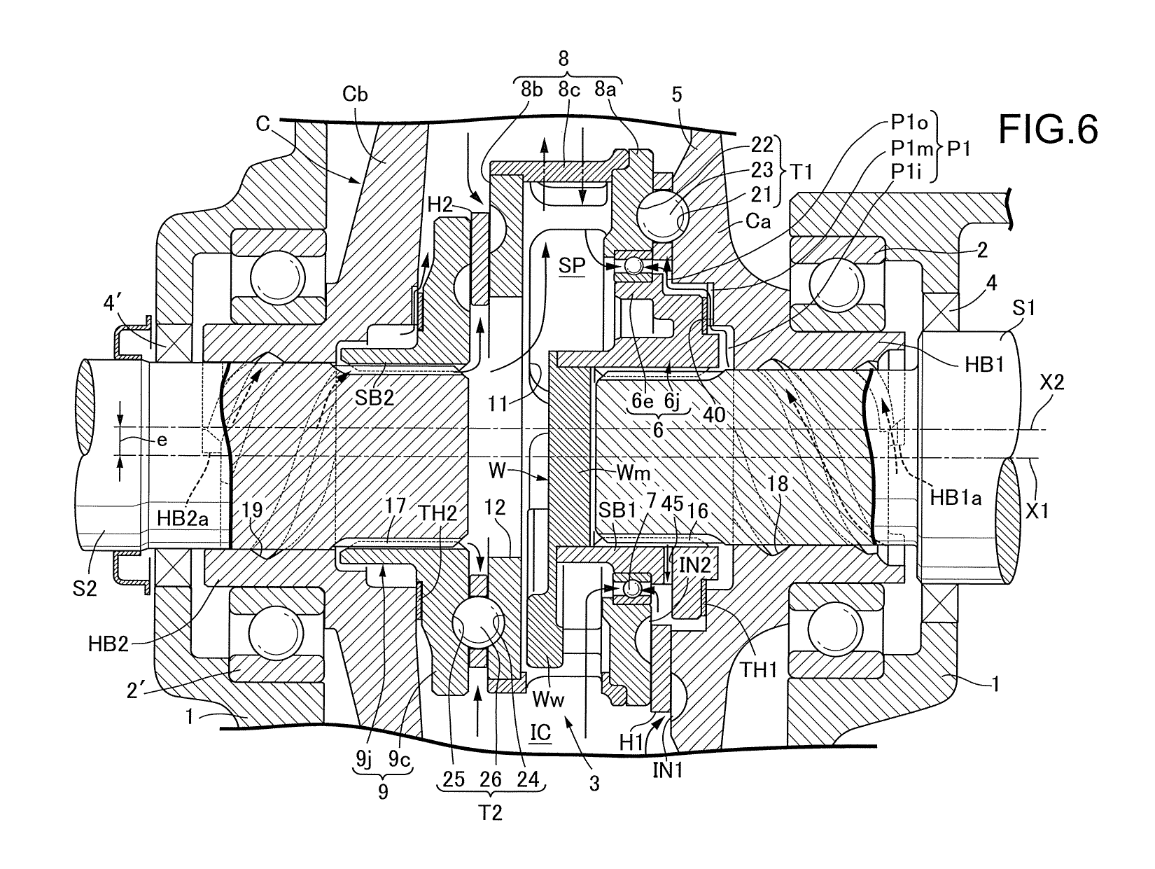

In the above torque transmission process of the differential device D, as described above, lubricating oil collecting in the bottom part of the transmission case 1 is stirred by means of the differential case C, etc. and is scattered over a wide range within the transmission case 1. Some of the scattered lubricating oil is actively supplied into the differential case C as shown in FIG. 6 by means of the drawing-in action of the helical grooves 18 and 19 accompanying relative rotation between the hubs HB1 and HB2 of the differential case C and the drive axles S1 and S2.

In this process, some of the lubricating oil that has reached the outlet of the first helical groove 18 in particular flows to the inner peripheral side of the first speed change mechanism T1 and the bearing 7 on the eccentric shaft portion 6e via the first oil passage P1 (that is, inner peripheral side oil passage portion P1i→intermediate oil passage portion P1m→outer peripheral side oil passage portion P1o) by virtue of centrifugal force, thus lubricating the first thrust washer TH1, the first speed change mechanism T1, and the bearing 7. Furthermore, the remainder of the lubricating oil, which has reached the outlet of the first helical groove 18, is combined in the outer peripheral side oil passage portion P1o of the first oil passage P1 via the oil hole 45 from the spline fitting part 16 (the spline tooth-missing part 43 in particular), thus lubricating the first speed change mechanism T1 and the bearing 7. In this case, in the present embodiment, since the opening on the inner end side of the hollow main shaft portion 6j of the eccentric rotating member 6 is blocked by the balance weight W, passing through of the lubricating oil within the main shaft portion 6j is restricted. Oil that has passed through the first speed change mechanism T1 flows into the internal space IC of the differential case C.

Furthermore, since the plurality of first oil flow holes 11 provided in the second transmission member 8 (the linking member 8c) open widely in the internal space IC of the differential case C, lubricating oil can move smoothly in and out between the internal space IC of the differential case C and the hollow part SP of the second transmission member 8 through the first oil flow holes 11. Therefore, some of the lubricating oil that has flowed into and been scattered in the internal space IC of the differential case C is also returned to the hollow part SP of the second transmission member 8 via the first oil flow hole 11.

In this way, during the process of torque transmission of the differential device D, in the interior of the differential case C, sliding sections of the first and second speed change mechanisms T1 and T2, the bearing 7, each of the thrust washers TH1 and TH2, etc. are lubricated effectively.

In particular, in accordance with the present embodiment, since there are provided the flat first transmission member 5 rotatable around the first axis X1, the eccentric rotating member 6, which integrally has the hollow main shaft portion 6j rotatable around the first axis X1 (that is, the first spline boss SB1 as a first output boss) and the eccentric shaft portion 6e having as a central axis the second axis X2 eccentric from the first axis X1, the second transmission member 8, which is disposed so as to oppose the first transmission member 5 and is rotatably supported on the eccentric shaft portion 6e, the flat third transmission member 9, which has the second spline boss SB2 as a second output boss rotatable around the first axis X1 and is disposed so as to oppose the second transmission member 8, the first speed change mechanism T1, which can transmit torque between the first and second transmission members 5 and 8 while changing the speed, and the second speed change mechanism T2, which can transmit torque between the second and third transmission members 8 and 9 while changing the speed, and the two speed change mechanisms T1 and T2 are arranged so that they drive the third transmission member 9 at a speed increase ratio of twice a speed of the first transmission member 5 when the eccentric rotating member 6 is fixed, the differential device D, which can easily be made flat and small in the axial direction, can be obtained.

Moreover, since one of the mating faces of the first drive axle S1 and the first hub HB1 of the differential case C is provided with the helical groove 18, which can, by virtue of relative rotation therebetween, draw in lubricating oil within the transmission case 1 from the outer end side of the first hub HB1 to the inner end side, and the first oil passage P1, which provides communication between the outlet of the helical groove 18 and the inner peripheral side of the first speed change mechanism T1, is provided between the differential case C and the eccentric rotating member 6, it is possible to draw in lubricating oil from the transmission case 1 side to the differential case C side through the helical groove 18, and subsequently efficiently supply the lubricating oil to the first speed change mechanism T1 side by making it be radially scattered between the differential case C and the eccentric rotating member 6 (the first oil passage P1) by virtue of centrifugal force. In this case, although the outlet of the helical groove 18 also communicates with the hollow part of the main shaft portion 6j, since the open end face of the inner end portion 6ja of the main shaft portion 6j is blocked by the balance weight W as a blocking member, it becomes possible to efficiently supply lubricating oil, which has come out of the outlet of the helical groove 18, to the first speed change mechanism T1 side without passing through the hollow part of the main shaft portion 6j.

Moreover, since the eccentric rotating member 6 has the oil hole 45, which guides lubricating oil that has flowed into the spline fitting part 16 between the first drive axle S1 and the main shaft portion 6j from the outlet of the helical groove 18 to the inner peripheral side of the first speed change mechanism T1, it becomes possible to supply lubricating oil that has flowed into the spline fitting part 16 (that is, the hollow part of the main shaft portion 6j) to the inner peripheral side of the first speed change mechanism T1 through the oil hole 45, thus enabling the first speed change mechanism T1 to be efficiently lubricated.

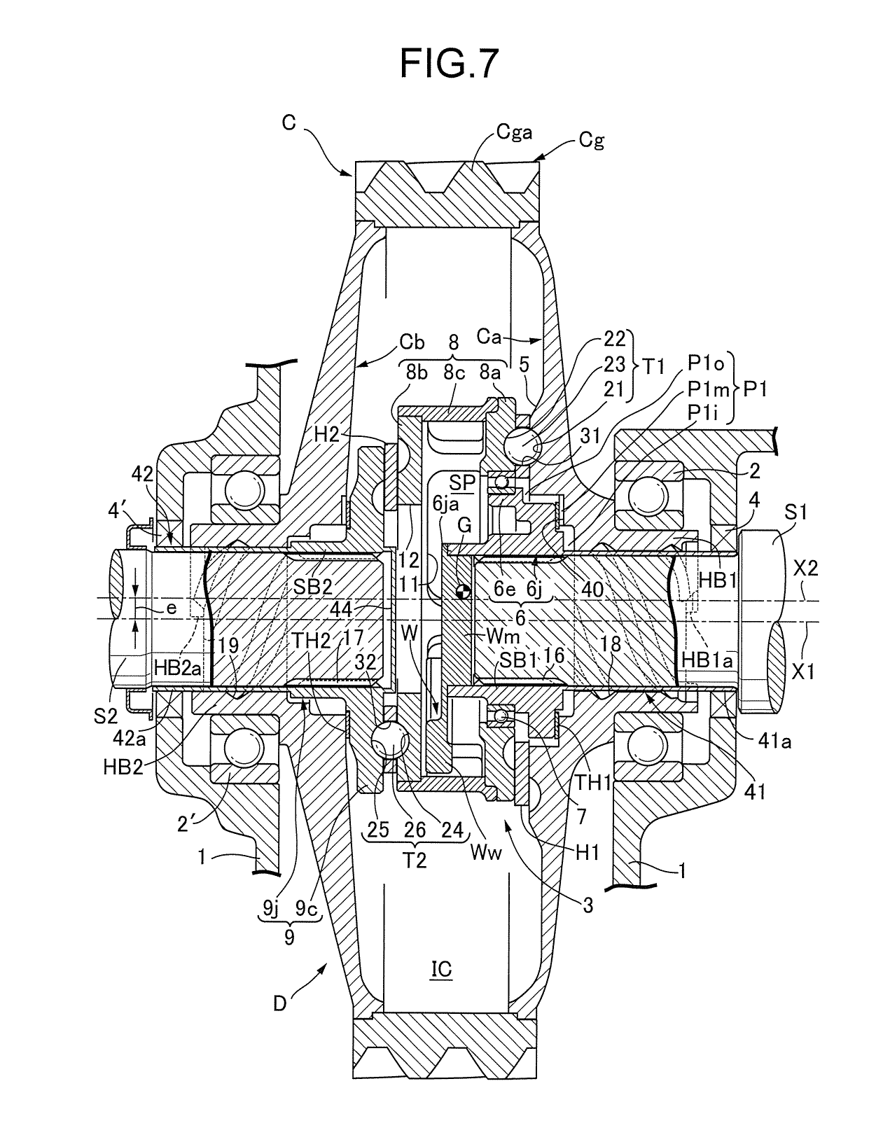

A second embodiment of the present invention is now explained by reference to FIG. 7. Coaxially, integrally, and connectedly provided with the main shaft portion 6j (the first spline boss SB1) of the eccentric rotating member 6 of the second embodiment is a first tubular shaft 41 that is rotatably fitted into and supported on the first hub HB1 of the differential case C, and coaxially, integrally, and connectedly provided with the main shaft portion 9j (the second spline boss SB2) of the third transmission member 9 is a second tubular shaft 42 that is rotatably fitted into and supported on the second hub HB2 of the differential case C.

The first helical groove 18 is provided in one of the mating faces of the first hub HB1 and the first tubular shaft 41 (in the illustrated example the first hub HB1), the first helical groove 18 being capable of drawing in lubricating oil within the transmission case 1 from the outer end side of the first hub HB1 to the inner end side by means of relative rotation between the first tubular shaft 41 and the first hub HB1, and the first oil passage P1 is provided between the differential case C and the eccentric rotating member 6, the first oil passage P1 providing communication between the outlet of the first helical groove 18 and the inner peripheral side of the first speed change mechanism T1 via the back face of the first thrust washer TH1.

Furthermore, one of the mating faces of the second hub HB2 and the second tubular shaft 42 (in the illustrated example the second hub HB2) is provided with the second helical groove 19 that can draw in lubricating oil within the transmission case 1 from the outer end side of the second hub HB2 to the inner end side by means of relative rotation between the second tubular shaft 42 and the second hub HB2. The arrangement of the first and second helical grooves 18 and 19 and the first oil passage P1 is the same as that in the first embodiment. When the first and second tubular shafts 41 and 42 have sufficient thickness, the first and second helical grooves 18 and 19 may be formed on the first and second tubular shafts 41 and 42 side.

Annular seal members 4 and 4′ are disposed between the transmission case 1 and outer peripheral parts of outer end portions 41a and 42a, extending from the first and second hubs HB1 and HB2, of the first and second tubular shafts 41 and 42, the seal members 4 and 4′ providing sealing therebetween. Furthermore, a blocking wall 44 is formed integrally with the hollow main shaft portion 9j of the third transmission member 9 (that is, the second spline boss SB2), the blocking wall 44 blocking an opening of the inner end side (the side opposite to second drive axle S2) of the hollow main shaft portion 9j. The blocking wall 44 may be formed as a separate body from the main shaft portion 9j and fixed to the main shaft portion 9j afterward.

Furthermore, a hole corresponding to the oil hole 45 of the first embodiment is not formed in the eccentric rotating member 6 of the second embodiment.

The arrangement is otherwise the same as that of the first embodiment; respective components are denoted by the same reference numerals and symbols as in the first embodiment, explanation thereof being omitted.

In accordance with the second embodiment, the same effects as those of the first embodiment can be achieved.

Moreover, in the present second embodiment, since not only is the opening on the inner end side of the hollow main shaft portion 6j of the eccentric rotating member 6 (the first spline boss SB1) blocked by the balance weight W, but the opening on the inner end side of the hollow main shaft portion 9j of the third transmission member 9 (the second spline boss SB2) is also blocked by the blocking wall 44 and, furthermore, since the eccentric rotating member 6 does not have the oil hole 45 of the first embodiment, even when the first drive axle S1 is pulled out from the main shaft portion 6j of the eccentric rotating member 6 (the first tubular shaft 41) and even when the second drive axle S2 is pulled out from the main shaft portion 9j of the third transmission member 9 (the second tubular shaft 42), it is possible to prevent lubricating oil within the transmission case 1 and the differential case C from leaking out, and the ease of maintenance becomes good.

Embodiments of the present invention are explained above, but the present invention may be modified in a variety of ways as long as the modifications do not depart from the gist of the present invention.

For example, in the embodiments, the differential device D is housed in the automobile transmission case 1, but the differential device D is not limited to an automobile differential device and may be implemented as a differential device for various machines and devices.

Furthermore, in the embodiments, the differential device D is applied to a left and right wheel transmission system, and one that distributes power to the left and right drive axles S1 and S2 while allowing differential rotation is illustrated, but in the present invention the differential device may be applied to a front and rear wheel transmission system of a front and rear wheel drive vehicle, and power may be distributed to front and rear drive wheels while allowing differential rotation.

Moreover, the second transmission member 8 of the embodiments is formed from the first and second half bodies 8a and 8b and the linking member 8c, but the second transmission member 8 may be one in which the second transmission groove 22 is provided in one face of one member and the third transmission groove 24 is provided in the other face.

Furthermore, in the embodiments, a rolling ball type speed change mechanism is used for both the first and second speed change mechanisms T1 and T2, but there is no limitation to the structure of the embodiments. That is, various types of speed change mechanisms including at least the eccentric rotating member and the second transmission member that can revolve around the first axis X1 and spin around the second axis in operative connection with rotation of the eccentric rotating member, for example, an inner contact type planetary gear mechanism or a cycloid speed-reducing gear (speed-increasing gear) or trochoid speed-reducing gear (speed-increasing gear) with various types of structure, may be applied to one or both of the first and second speed change mechanisms.

Moreover, in the embodiments, one in which the structure is simplified by using the balance weight W also as a blocking member for blocking the opening on the inner end side (that is, the side opposite to the first drive axle S1) of the hollow part of the first spline boss SB1 as a first output boss is shown, but in the present invention the opening may be blocked with an exclusive blocking member such as a plug and the like. In this case, the blocking member may be formed integrally with the main shaft portion 6j (the first spline boss SB1) or may be formed as a separate body and fixed to the main shaft portion 6j afterward.

Furthermore, in the embodiments, one in which the balance weight W is housed in the hollow part SP of the second transmission member 8 is illustrated, but the position where the balance weight W is disposed is not limited to that of the embodiments, and it may be disposed for example on the outside of the second transmission member 8, and the like.

Moreover, in the embodiments, each of the transmission grooves 21, 22; 24, 25 of the first and second speed change mechanisms T1 and T2 is a wave-shaped annular groove along a trochoidal curve, but these transmission grooves are not limited to those of the embodiments, and may be for example a wave-shaped annular groove along a cycloidal curve.

Furthermore, in the embodiments, one in which the ball-shaped first and second rolling bodies 23 and 26 are disposed between the first and second transmission grooves 21 and 22 of the first and second speed change mechanisms T1 and T2 and between the third and fourth transmission grooves 24 and 25 is shown, but the rolling body may be in the form of a roller or a pin, and in this case the first and second transmission grooves 21 and 22 and the third and fourth transmission grooves 24 and 25 are formed so as to have an inside face shape that enables a roller- or pin-shaped rolling body to roll.

Moreover, in the embodiments, one in which the eccentric rotating member 6 and the third transmission member 9 are connected (by the spline fittings 16 and 17) to the drive axles S1 and S2 supported on the differential case C and are supported on the differential case C via the drive axles S1 and S2 is illustrated, but in the present invention the eccentric rotating member 6 and the third transmission member 9 may be supported directly on the differential case C.

Furthermore, in the embodiments, one in which the first and second retaining members H1 and H2 are formed from an annular ring whose inner and outer peripheral faces are each true circles is shown, but the shape of the first and second retaining members of the present invention is not limited to that of the embodiments; they may be an annular body that can retain at least the plurality of first and second rolling balls 23 and 26 at fixed intervals, and they may be for example an elliptical annular body or an annular body curved into a wave shape.

Moreover, in the embodiments, one in which the first and second speed change mechanisms T1 and T2 each include the first and second retaining members H1 and H2 rotatably retaining the plurality of first and second transmission balls 23 and 26 respectively at predetermined intervals is illustrated, but when the first and second transmission balls 23 and 26 can smoothly roll in the transmission grooves 21, 22, 24, and 25 without the first and second retaining members H1 and H2, the first and second retaining members H1 and H2 can be omitted.

1. A differential device comprising:
a differential case that has first and second hubs arranged on a first axis on opposite side parts, is disposed within a transmission case, and rotates around the first axis upon being subjected to rotational power,
a first transmission member that can rotate around the first axis together with the differential case,
an eccentric rotating member that has integrally linked a hollow first output boss and an eccentric shaft portion, the first output boss being capable of rotating around the first axis, and the eccentric shaft portion having as a central axis a second axis that is eccentric from the first axis,
a second transmission member that is disposed so as to oppose the first transmission member and is rotatably supported on the eccentric shaft portion,
a third transmission member that has a hollow second output boss and is disposed so as to oppose the second transmission member, the second output boss being capable of rotating around the first axis,
a first speed change mechanism that can transmit torque between the first and second transmission members while changing a speed, and
a second speed change mechanism that can transmit torque between the second and third transmission members while changing a speed,
the first and second speed change mechanisms driving the third transmission member with a speed increase ratio of twice a speed of the first transmission member when the eccentric rotating member is fixed,
wherein the first output boss is spline fitted via a hollow part of the first output boss onto a first drive shaft rotatably fitted into and supported on the first hub and the second output boss is spline fitted via a hollow part of the second output boss onto a second drive shaft rotatably fitted into and supported on the second hub, and
one of mating faces of the first drive shaft and the first hub is provided with a helical groove that can draw in lubricating oil within the transmission case by means of relative rotation between the first hub and the first drive shaft from an outer end side of the first hub to an inner end side, and an oil passage is provided between the differential case and the eccentric rotating member, the oil passage providing communication between an outlet of the helical groove and an inner peripheral side of the first speed change mechanism.

2. The differential device according to claim 1, wherein the eccentric rotating member is provided with an oil hole, the oil hole guiding lubricating oil that has flowed from the outlet of the helical groove into a spline fitting part between the first drive shaft and the first output boss toward the inner peripheral side of the first speed change mechanism.

3. The differential device according to claim 1, wherein an opening, on a side opposite to the helical groove, of the hollow part of the first output boss is blocked.

4. A differential device comprising:
a differential case that has first and second hubs arranged on a first axis on opposite side parts, is disposed within a transmission case, and rotates around the first axis upon being subjected to rotational power,
a first transmission member that can rotate around the first axis together with the differential case,
an eccentric rotating member that has integrally linked a hollow first output boss and an eccentric shaft portion, the first output boss being capable of rotating around the first axis, and the eccentric shaft portion having as a central axis a second axis that is eccentric from the first axis,
a second transmission member that is disposed so as to oppose the first transmission member and is rotatably supported on the eccentric shaft portion,
a third transmission member that has a hollow second output boss and is disposed so as to oppose the second transmission member, the second output boss being capable of rotating around the first axis,
a first speed change mechanism that can transmit torque between the first and second transmission members while changing a speed, and
a second speed change mechanism that can transmit torque between the second and third transmission members while changing a speed,
the first and second speed change mechanisms driving the third transmission member with a speed increase ratio of twice a speed of the first transmission member when the eccentric rotating member is fixed,
wherein the first output boss is spline fitted via a hollow part of the first output boss onto a first drive shaft rotatably fitted into and supported on the first hub and the second output boss is spline fitted via a hollow part of the second output boss onto a second drive shaft rotatably fitted into and supported on the second hub,
the first output boss is integrally and connectedly provided with a first tubular shaft rotatably fitted into and supported on the first hub,
one of mating faces of the first hub and the first tubular shaft is provided with a first helical groove that can draw in lubricating oil within the transmission case by means of relative rotation between the first tubular shaft and the first hub from an outer end side of the first hub to an inner end side, and an oil passage is provided between the differential case and the eccentric rotating member, the oil passage providing communication between an outlet of the first helical groove and an inner peripheral side of the first speed change mechanism.

5. The differential device according to claim 4, wherein the second output boss is integrally and connectedly provided with a second tubular shaft rotatably fitted into and supported on the second hub,
an opening, on a side opposite to the first drive shaft, of the hollow part of the first output boss and an opening, on a side opposite to the second drive shaft, of the hollow part of the second output boss are blocked, and
a seal member is disposed between the transmission case and an outer end part of each of the first and second tubular shafts extending outward from the first and second hubs respectively.

6. The differential device according to claim 1, wherein the first speed change mechanism comprises a wave-shaped annular first transmission groove that is present on a face, opposing the second transmission member, of the first transmission member and has the first axis as a center, a wave-shaped annular second transmission groove that is present on a face, opposing the first transmission member, of the second transmission member, has the second axis as a center, and has a different wave number from that of the first transmission groove, and a plurality of first rolling bodies that are each disposed in a plurality of intersecting parts between the first and second transmission grooves and are involved in speed change and transmission between the first and second transmission members while rolling in the first and second transmission grooves,
the second speed change mechanism comprises a wave-shaped annular third transmission groove that is present on a face, opposing the third transmission member, of the second transmission member and has the second axis as a center, a wave-shaped annular fourth transmission groove that is present on a face, opposing the second transmission member, of the third transmission member, has the first axis as a center, and has a different wave number from that of the third transmission groove, and a plurality of second rolling bodies that are each disposed in a plurality of intersecting parts between the third and fourth transmission grooves and are involved in speed change and transmission between the second and third transmission members while rolling in the third and fourth transmission grooves, and
when the wave number of the first transmission groove is Z1, the wave number of the second transmission groove is Z2, the wave number of the third transmission groove is Z3, and the wave number of the fourth transmission groove is Z4, (Z1/Z2)×(Z3/Z4)=2 holds.

7. The differential device according to claim 3, wherein the first speed change mechanism comprises a wave-shaped annular first transmission groove that is present on a face, opposing the second transmission member, of the first transmission member and has the first axis as a center, a wave-shaped annular second transmission groove that is present on a face, opposing the first transmission member, of the second transmission member, has the second axis as a center, and has a different wave number from that of the first transmission groove, and a plurality of first rolling bodies that are each disposed in a plurality of intersecting parts between the first and second transmission grooves and are involved in speed change and transmission between the first and second transmission members while rolling in the first and second transmission grooves,
the second speed change mechanism comprises a wave-shaped annular third transmission groove that is present on a face, opposing the third transmission member, of the second transmission member and has the second axis as a center, a wave-shaped annular fourth transmission groove that is present on a face, opposing the second transmission member, of the third transmission member, has the first axis as a center, and has a different wave number from that of the third transmission groove, and a plurality of second rolling bodies that are each disposed in a plurality of intersecting parts between the third and fourth transmission grooves and are involved in speed change and transmission between the second and third transmission members while rolling in the third and fourth transmission grooves, and
when the wave number of the first transmission groove is Z1, the wave number of the second transmission groove is Z2, the wave number of the third transmission groove is Z3, and the wave number of the fourth transmission groove is Z4, (Z1/Z2)×(Z3/Z4)=2 holds.

8. The differential device according to claim 2, wherein an opening, on a side opposite to the helical groove, of the hollow part of the first output boss is blocked.

9. The differential device according to claim 2, wherein the first speed change mechanism comprises a wave-shaped annular first transmission groove that is present on a face, opposing the second transmission member, of the first transmission member and has the first axis as a center, a wave-shaped annular second transmission groove that is present on a face, opposing the first transmission member, of the second transmission member, has the second axis as a center, and has a different wave number from that of the first transmission groove, and a plurality of first rolling bodies that are each disposed in a plurality of intersecting parts between the first and second transmission grooves and are involved in speed change and transmission between the first and second transmission members while rolling in the first and second transmission grooves,
the second speed change mechanism comprises a wave-shaped annular third transmission groove that is present on a face, opposing the third transmission member, of the second transmission member and has the second axis as a center, a wave-shaped annular fourth transmission groove that is present on a face, opposing the second transmission member, of the third transmission member, has the first axis as a center, and has a different wave number from that of the third transmission groove, and a plurality of second rolling bodies that are each disposed in a plurality of intersecting parts between the third and fourth transmission grooves and are involved in speed change and transmission between the second and third transmission members while rolling in the third and fourth transmission grooves, and
when the wave number of the first transmission groove is Z1, the wave number of the second transmission groove is Z2, the wave number of the third transmission groove is Z3, and the wave number of the fourth transmission groove is Z4, (Z1/Z2)×(Z3/Z4)=2 holds.

10. The differential device according to claim 4, wherein the first speed change mechanism comprises a wave-shaped annular first transmission groove that is present on a face, opposing the second transmission member, of the first transmission member and has the first axis as a center, a wave-shaped annular second transmission groove that is present on a face, opposing the first transmission member, of the second transmission member, has the second axis as a center, and has a different wave number from that of the first transmission groove, and a plurality of first rolling bodies that are each disposed in a plurality of intersecting parts between the first and second transmission grooves and are involved in speed change and transmission between the first and second transmission members while rolling in the first and second transmission grooves,
the second speed change mechanism comprises a wave-shaped annular third transmission groove that is present on a face, opposing the third transmission member, of the second transmission member and has the second axis as a center, a wave-shaped annular fourth transmission groove that is present on a face, opposing the second transmission member, of the third transmission member, has the first axis as a center, and has a different wave number from that of the third transmission groove, and a plurality of second rolling bodies that are each disposed in a plurality of intersecting parts between the third and fourth transmission grooves and are involved in speed change and transmission between the second and third transmission members while rolling in the third and fourth transmission grooves, and
when the wave number of the first transmission groove is Z1, the wave number of the second transmission groove is Z2, the wave number of the third transmission groove is Z3, and the wave number of the fourth transmission groove is Z4, (Z1/Z2)×(Z3/Z4)=2 holds.

11. The differential device according to claim 5, wherein the first speed change mechanism comprises a wave-shaped annular first transmission groove that is present on a face, opposing the second transmission member, of the first transmission member and has the first axis as a center, a wave-shaped annular second transmission groove that is present on a face, opposing the first transmission member, of the second transmission member, has the second axis as a center, and has a different wave number from that of the first transmission groove, and a plurality of first rolling bodies that are each disposed in a plurality of intersecting parts between the first and second transmission grooves and are involved in speed change and transmission between the first and second transmission members while rolling in the first and second transmission grooves,
the second speed change mechanism comprises a wave-shaped annular third transmission groove that is present on a face, opposing the third transmission member, of the second transmission member and has the second axis as a center, a wave-shaped annular fourth transmission groove that is present on a face, opposing the second transmission member, of the third transmission member, has the first axis as a center, and has a different wave number from that of the third transmission groove, and a plurality of second rolling bodies that are each disposed in a plurality of intersecting parts between the third and fourth transmission grooves and are involved in speed change and transmission between the second and third transmission members while rolling in the third and fourth transmission grooves, and
when the wave number of the first transmission groove is Z1, the wave number of the second transmission groove is Z2, the wave number of the third transmission groove is Z3, and the wave number of the fourth transmission groove is Z4, (Z1/Z2)×(Z3/Z4)=2 holds.
